(19) United States
(12) Patent Application Publication
(10) Pub. No.: US 2008/0120859 A1
(43) Pub. Date: May 29, 2008

(54) Marking Device

(76) Inventor: Martin Jan Peter Eversdijk, Nieuw Vennep (NL)

Correspondence Address: HARNESS, DICKEY & PIERCE, P.L.C., P.O. BOX 8910, RESTON, VA, 20195, US

(21) Appl. No.: 11/663,286

(22) PCT Filed: Oct. 6, 2005
(86) PCT No.: PCT/NL05/50008

§ 371 Date: Nov. 13, 2007

(30) Foreign Application Priority Data
Oct. 7, 2004 (NL) 1027229

(51) Int. Cl. B43L 7/00

(52) U.S. Cl. 33/483

(57) ABSTRACT

A marking device intended for marking objects or locations relating to criminal offences, accidents and the like is disclosed. In at least one embodiment, the marking device includes an elongated body including an arrow-shaped indicator at one end thereof, wherein the body is furthermore provided with linear measurement indicators along a substantial part of its length on at least one side.

The invention relates to a marking device intended for marking objects or locations relating to criminal offences, accidents and the like, comprising an elongated body having an arrow-shaped indicator at one end thereof.

The body of the known marking device is made of plastic material, substantially in the form of a strip (186 mm long, 20 mm wide, 1 mm thick), whilst the arrow-shaped indicator is formed by the arrow-shaped end of the strip. The strip may also be made of another material, such as a metal or cardboard. The known marking device has a conspicuous fluorescent orange colour on both sides, with the word “POLICE” being present on one side.

The indicators are laid on the ground at the site of an offence, for example by a police officer, to indicate objects that are of special importance, or to indicate a route offenders have followed, for example, all this with a view to preserving evidence. The arrows tell third parties not to set foot on or touch the indicated objects.

Frequently photos are made of the site of the offence in order to record evidence. In those cases in which the dimensions of evidence are expected to be relevant at a later stage, measuring strips provided with a distinct graduation, for example chequered black and white, and marking circles at laid on the ground, so that they are photographically recorded together with the object and can be measured at a later stage.

Frequently it appears afterwards that such measuring strips are missing from a photographed image or that they were not placed close enough to an object, because its importance was not realised yet when the photos were taken, for example because a particular object was not recognized as evidence at that point.

The object of the invention is to provide means by which evidence can be preserved more adequately.

In order to accomplish that object, the body of the marking device is furthermore provided with linear measurement indicators along a substantial part of its length on at least one side. Preferably, linear measurement indicators are provided on both sides of the strip. Because usually marking strips are used in large numbers, the chance of a multitude of measuring strips being present on a photo of a crime site or an accident site is significantly increased, so that it will be possible to determine the dimensions of objects with a higher degree of accuracy.

The linear measurement indicators may be grade marks of a metric graduation or a British graduation. Furthermore, the linear measurement indicators may comprise mutually contrasting blocks of identical length. Furthermore, the linear measurement indicators may comprise letters of identical width that jointly form a word. With the known marking device, a proportional typeface is used for the letters of the word “POLICE”, so that these letters are unsuitable for use as linear measurement indicators.

Preferably, the marking device is furthermore provided with marking circles near its ends. Such marking circles, which usually consist of circles comprising segments of contrasting colours, further help to determine the dimensions of objects captured on photos.

The body is preferably provided with holes by means of which the marking device can be fixed in the ground order to another object.

The invention will now be explained in more detail by means of an embodiment as shown in the figures, in which:

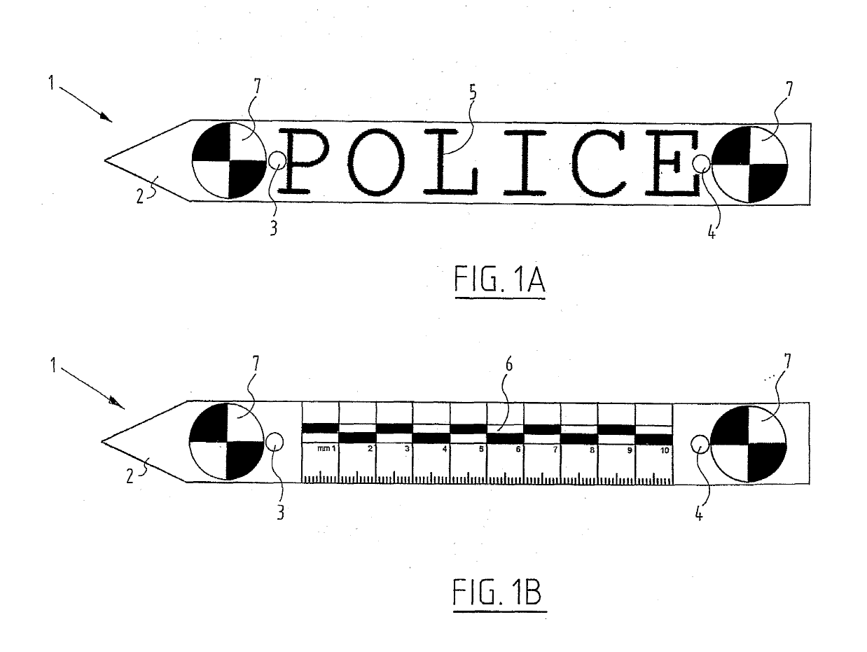

FIG. 1A is a front view of a marking device;

FIG. 1B is a rear view of the marking device that is shown in FIG. 1A; and

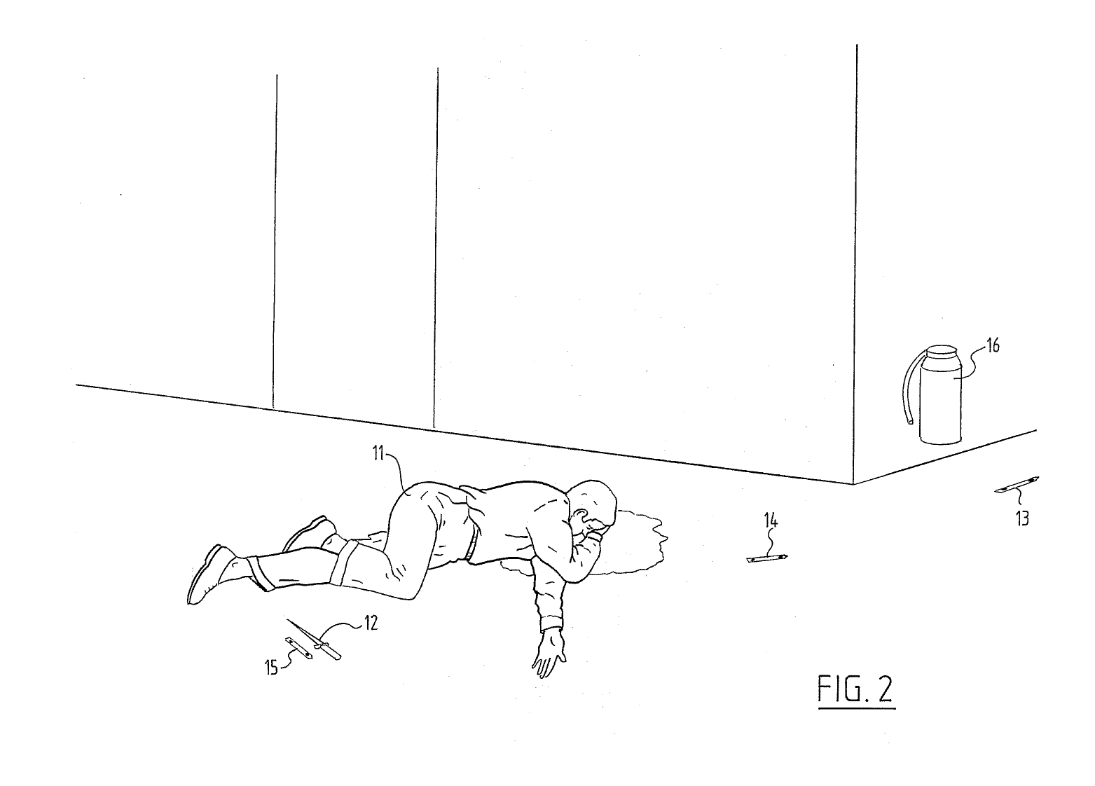

FIG. 2 is a sketch of a situation in which the marking device of FIGS. 1A and 1B is used.

The marking device 1 as shown in FIGS. 1A and 1B comprises a strip-shaped body provided with a pointed, arrow-shaped end 2 and with fixing holes 3, 4 near both ends. The strip-shaped body is made of plastic material having a thickness of about 1 mm.

Linear measurement indicators are printed on both sides of the marking device 1. Present on one side is a word 5, the word “POLICE” in the embodiment as shown in FIG. 1A, whose letters and spaces have a fixed width. This makes it possible to use the letters and spaces as linear measurement indicators. Present on the other side is a metric graduation 6, consisting of a black and white chequered beam 6 and a line division. Furthermore, a black and white chequered marking circle 7 is present on both sides. Since the spacing between the marking circles 7 is the same at all times, use can be made of this fact in determining the dimensions of an object.

The sample situation of FIG. 2 shows a wounded person 11 and a knife 12 lying near said person. Marking strips 13, 14 have been laid on the route from the door of the space to the person, whilst a marking strip 15 has been laid on the ground near the knife 12 that is presumed to have been used as a stabbing weapon.

Upon subsequent investigation it appeared, however, that the knife 12 had not been used for wounding the victim. It was established that the victim 11 had been wounded with a large, heavy object of a specific shape and dimensions. Since the photo shows a marking strip 13 lying close to a fire extinguisher 16, the dimensions of the fire extinguisher can easily be determined with a high degree of certainty. From said determination it can be derived whether the fire extinguisher 16 may have been used for inflicting the specific injuries that the victim 11 was found to have.

If marking devices 13, 14, 15 not provided with linear measurement indicators had been used, the use of linear measurement indicators would probably have been confined to one linear measurement indicator placed close enough to the knife 12 for determining the dimensions thereof with a sufficient degree of accuracy from a photo.

1. A marking device to mark at least one of objects and locations, comprising:
an elongated body including an arrow-shaped indicator at one end thereof, and including linear measurement indicators along a substantial part of a length of the elongated body on at least one side.

2. A marking device according to claim 1, wherein said body is substantially strip-shaped.

3. A marking device according to claim 2, wherein linear measurement indicators are provided on both sides of the strip.

4. A marking device according to claim 1, wherein the linear measurement indicators include grade marks of at least one of a metric graduation and a British graduation.

5. A marking device according to claim 1, wherein the linear measurement indicators include mutually contrasting blocks of identical length.

6. A marking device according to claim 1, wherein the linear measurement indicators include letters of identical width that jointly form a word.

7. A marking device according to claim 1, further comprising marking circles near at least one end of the marking device.

8. A marking device according to claim 1 wherein the arrow-shaped indicator is formed by the arrow-shaped end of the elongated body.

9. A marking device according to claim 1, wherein said body is provided with holes by which the marking device is fixable at least one of in the ground and to an object.

10. A marking device according to claim 2, wherein the linear measurement indicators include grade marks of at least one of a metric graduation and a British graduation.

11. A marking device according to claim 2, wherein the linear measurement indicators include mutually contrasting blocks of identical length.

12. A marking device according to claim 2, wherein the linear measurement indicators include letters of identical width that jointly form a word.

13. A marking device according to claim 3, wherein the linear measurement indicators include grade marks of at least one of a metric graduation and a British graduation.

14. A marking device according to claim 3, wherein the linear measurement indicators include mutually contrasting blocks of identical length.

15. A marking device according to claim 3, wherein the linear measurement indicators include letters of identical width that jointly form a word.
